(19) United States
(12) Patent Application Publication
(10) Pub. No.: US 2023/0031434 A1
(43) Pub. Date: Feb. 2, 2023

(54) EXCLUSION REGISTRY

(71) Applicant: Hewlett-Packard Development Company, L.P., Spring, TX (US)

(72) Inventor: Tirath Ramdas, Hawthorn (AU)

(21) Appl. No.: 17/387,673

(22) Filed: Jul. 28, 2021

(51) Int. Cl. H04L 29/06; G06F 21/57

(52) U.S. Cl. CPC H04L 63/20; G06F 21/577; H04L 67/40

(57) ABSTRACT

In an example implementation according to aspects of the present disclosure, a system, method, and storage medium. The system receives a request to enroll a third-party software package. The system creates an entry in an exclusion registry. The system may retrieve a system-level exclusion policy and compare it against the registered exclusion. Responsive to the comparing, the system may omit the third-party software from an endpoint protection control.

### BACKGROUND

Information technology groups set and enforce policies for the safety of organizations they support. Endpoint protection software often is utilized as the tool for the enforcement of such policies.

### BRIEF DESCRIPTION OF THE DRAWINGS

FIG. 1 is a block diagram of a system for supporting an exclusion registry, according to an example;

FIG. 2 is block diagram of another system for supporting an exclusion registry, according to another example;

FIG. 3 illustrates a method for creating an exclusion registry according to an example; and

FIG. 4 is a computing device for supporting instructions for an exclusion registry, according to an example.

### DETAILED DESCRIPTION

Information technology (IT) administrators often have to manage fleets of computing devices including but not limited to laptops, desktops, servers, and handhelds such as mobile phones and tablets. Each device may represent an entry point for malware to enter a controlled network. IT administrators often utilize endpoint protection tools to deploy system level policies regarding security aspects to be maintained. The endpoint protection tools may include scanning software to enforce the policies as well as to detect and quarantine any discovered malware.

In some fleet deployments, a computing device may include pieces of software that generate false positives of malware infection. The false positives may incorrectly indicate an infection and alert an IT administrator to that incorrectly identified threat, thereby diverting the administrator's time. System level exclusion policies may direct the endpoint protection software to exclude certain applications and/or directory paths from examination. The system level exclusion policies may direct a certain effect on the system by the types of exclusion policies enacted. The act of scanning using an endpoint protection application may affect performance regardless of any issues discovered. For this reason, an exclusion policy may be created to limit the paths and applications scanned to mitigate performance issues. For example, a system level exclusion policy may be directed toward performance, thereby excluding more applications and paths from the endpoint protection application for performance purposed. Another example is directed to operational criticality, whereby an endpoint protection application may interfere with the operation of critical processes on the system.

In many implementations, the system level exclusion policies are crafted by the IT administrator's hand. The bespoke nature of the exclusion polices may leave some computing devices vulnerable to malware. In other cases, system level exclusion policies may be obsolete due to software uninstallation or update, leading to increased complexity and error correction in the endpoint protection application itself.

Described herein is an exclusion registry. The exclusion registry provides support to enable endpoint protection software to properly and efficiently implement a system level exclusion policy. The exclusion registry may include an application programming interface, an exclusions manager, and the exclusion registry itself.

In one example, the exclusion registry may include a processor and memory. The memory may include instructions that when executed cause the processor to receive a request to enroll in the exclusion registry. The processor may create an entry in the exclusion registry. The processor may retrieve a system exclusion policy and compare it to the request. Based on the comparison, the processor may omit third party software from the endpoint protection control.

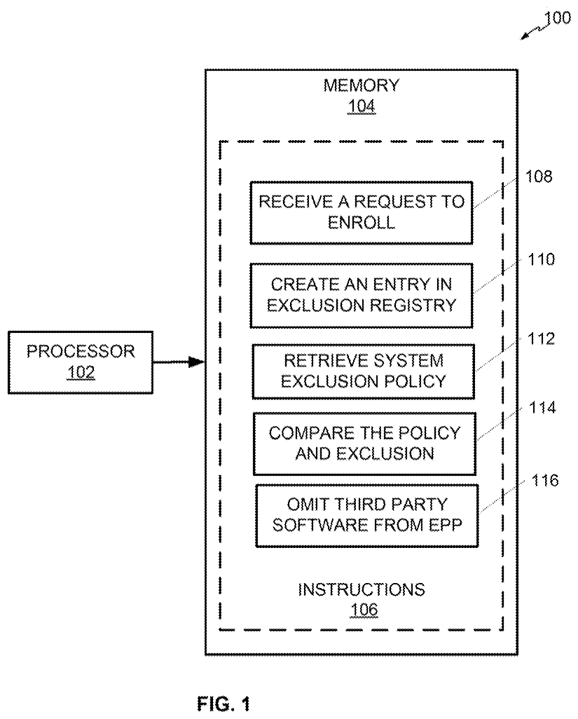

FIG. 1 is a block diagram of a system for supporting an exclusion registry, according to an example. The processor 102 of the device 100 may be implemented as dedicated hardware circuitry or a virtualized logical processor. The dedicated hardware circuitry may be implemented as a central processing unit (CPU). A dedicated hardware CPU may be implemented as a single to many-core general purpose processor. A dedicated hardware CPU may also be implemented as a multi-chip solution, where more than one CPU are linked through a bus and schedule processing tasks across the more than one CPU.

A virtualized logical processor may be implemented across a distributed computing environment. A virtualized logical processor may not have a dedicated piece of hardware supporting it. Instead, the virtualized logical processor may have a pool of resources supporting the task for which it was provisioned. In this implementation, the virtualized logical processor may be executed on hardware circuitry; however, the hardware circuitry is not dedicated. The hardware circuitry may be in a shared environment where utilization is time sliced. In some implementations the virtualized logical processor includes a software layer between any executing application and the hardware circuitry to handle any abstraction which also monitors and save the application state. Virtual machines (VMs) may be implementations of virtualized logical processors.

A memory 104 may be implemented in the device 100. The memory 104 may be dedicated hardware circuitry to host instructions for the processor 102 to execute. In another implementation, the memory 104 may be virtualized logical memory. Analogous to the processor 102, dedicated hardware circuitry may be implemented with dynamic random-access memory (DRAM) or other hardware implementations for storing processor instructions. Additionally, the virtualized logical memory may be implemented in a software abstraction which allows the instructions 106 to be executed on a virtualized logical processor, independent of any dedicated hardware implementation.

The device 100 may also include instructions 106. The instructions 106 may be implemented in a platform specific language that the processor 102 may decode and execute. The instructions 106 may be stored in the memory 104 during execution. The instructions 106 may include instructions to receive a request to enroll an exclusion registration from a third-party software 108. The system 100 may include an application programming interface (API). The API may include a request/response mechanism, similar to get/set members of traditional interfaces. The exclusion registration in the request may include information corresponding to a type of exclusion. For example, operational and performance exclusion types may be packaged in the exclusion registration. The operation exclusion type may correspond to an exclusion of a third-party application or path based on criticality to the operation of a system. One special case of this category is endpoint protection application monitoring of other endpoint protection solutions. For example, endpoint management software monitoring antivirus software. In this example, because antivirus software manipulates any detected malware, from a system monitoring perspective, the manipulation may appear as though antivirus software itself is generating malware. The performance type of exclusion may be utilized as a direct effort to lessen the impact on system performance of a third-party software through the endpoint protection application. An exclusion for this type may include paths with many subtrees and files with low risk of malware infection. The traversal of the paths may adversely affect system performance while rarely generating a problem.

In addition to the exclusion type, the exclusion registration may also include a path type and a path. A path type may include relative paths and environmental variables to define the path type and may be relative to the installation path of the third-party software. The path may be a literal string path of the exclusion including wildcarding. Additionally, the request may include the publisher of the exclusion registration. The request may be cryptographically signed by the publisher. The processor 102 may validate the signature to authenticate that the request was indeed sent by the publisher.

The instructions 106 may include instructions to create an entry in an exclusion registry for the exclusion registration 110. Upon receipt of the request via an API, an entry may be created in the exclusion registry. For any given exclusion, not request, an entry may be created in the exclusion registry. The entry may be a uniquely identified structure. The entry may be unique based on the exclusion type, the publisher, the path type, and any included paths. An identifier may be created based on some combination of these attributes. In some implementations the attributes may be hashed. The exclusion registry tracks a counter corresponding to the exclusion registration for the third-party software at completion. Subsequent requests for a given exclusion may be deduplicated, by not creating a new entry in the exclusion registry but instead incrementing a counter corresponding to the existing exclusion. For example, exclusion A has been requested five times. In the exclusion registry, there is one entry for exclusion A however, a field corresponding to a counter associated with exclusion A may be incremented to five to mirror the number of requests. Likewise, if request for deletion occurs for exclusion A, the counter may be decremented by one. Upon the counter reaching zero, the entry in the exclusion registry may be deleted.

The instructions 106 may include instructions to retrieve a system exclusion policy from a system registry 112. A system exclusion policy may correspond to allow-listed or deny-listed publishers and a policy type. As described in relation to the exclusion type, the policy type may include but is not limited to an operational type or a performance type.

The instructions 106 may include instructions to compare the system exclusion policy against the exclusion registration 114. The system 100 may compare the system exclusion policy by evaluating the types of the system exclusion policy to the exclusion registration. For example, if the system exclusion policy type is “operational,” only registry entries from received exclusion registration requests with corresponding “operational” types may be enabled. Additionally, the system exclusion policy validates that the publisher of the exclusion registration is an approved publisher based on an allow-list or deny-list.

The instructions 106 may include instructions to, responsive to the comparing, omit a third-party executable from the third-party software from being subject to an endpoint protection control 116. If the exclusion is of the correct type and either on the allow-list or not on the deny-list, the exclusion registration may be effectuated. The endpoint protection application may omit the paths and path types corresponding to the exclusion registration. In one implementation, the endpoint protection application may not have awareness of the exclusion registry. In this implementation, an exclusion manager may update configuration files of the endpoint protection application to insert the corresponding paths and path types of the exclusion registration. In an implementation in that the endpoint protection application is aware, the exclusion manager may convey the paths and path types to the endpoint protection application directly through inter-process communication. Additionally, the instructions 106 may include instructions to, update a scan path for the endpoint protection application corresponding to an installed path of the third-party software. In this implementation, entire paths for the endpoint protection application may be omitted from scanning.

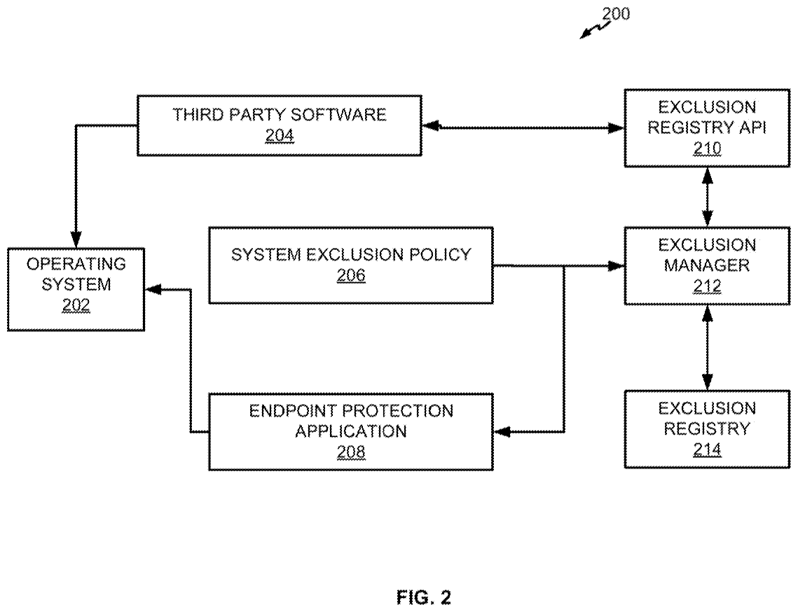

FIG. 2 is block diagram of another system 200 for supporting an exclusion registry, according to another example. FIG. 2 may correspond to a logical representation of the system 100 in FIG. 1. References to components in FIG. 1 may be utilized here for illustrative purposes. The system 200 may correspond to a computing device such as a laptop, desktop, workstation, server, or handheld computing device such as a mobile phone or tablet.

The system 200 may include an operating system 202. The operating system 202 implements some of the low-level constructs necessary to implement the exclusion registry. The low-level constructs may include kernels, file systems, input/output, etc. Examples of applicable operating systems may include Windows® (WINDOWS is a registered trademark of Microsoft Corporation, Redmond Wash., USA), Linux, and ChromeOS™ (CHROMEOS is a trademark of Google LLC, Mountain View, Calif., USA).

A third-party software 204 package may be installed into the system. The third-party software 204 package may be bundled into an installer application such as a Windows Installer package (*.msi file) for WINDOWS or a Debian package (*.deb file) for Debian Linux. The third-party software 204 may include any relevant executables or supporting files to implement a distributable application. In some instances, the third-party software 204 may also include patches or upgrades to currently installed applications. The package may build the exclusion registration request and present it to exclusion registry API 210. Likewise, upon uninstallation of the third-party software 204 package, the third-party software may build the exclusion de-registration request and present it to the exclusion registry API 210. In one implementation, the exclusion registry API 210 may be a well-defined interface utilizing a human readable language such as javascript object notation (JSON). The interface may correspond with commands (e.g. registration request, de-registration request) as well as parameterized fields indicating the exclusion type, the publisher, as well as the path type, and path. In another implementation, the exclusion registry API 210 may include a protocol for secure authentication and authorization authentication the third-party software 204.

The exclusion manager 212 may be a process executing on the processor 102. In one implementation the exclusion manager 212 may operate as a service within the operating system 202. The exclusion manager 212 may be implemented as a listener of exclusion registry API 210. The exclusion manager 212 may receive requests for exclusion registration or de-registration through the exclusion registry API 210. The exclusion manager 212 may utilize the exclusion registry API 210 to unpackage or decode any request received via the exclusion registry API 210. The exclusion manager 212 maintains the exclusion registry 214 and interacts with the system 200. The exclusion manager 212 may retrieve the system exclusion policy 206. The exclusion manager 212 verifies the exclusion registrations against the system exclusion policy 206 to make sure the correct exclusions are effectuated for the system exclusion policy.

The exclusion registry 214 may be a logical storage unit for the exclusion registrations. The exclusion registry 214 may be implemented in a data structure accessible by the exclusion manager 212. In most implementations, the exclusion registry 214 may be accessible only by the exclusion manager 212, and in yet some of those implementations, the exclusion registry 214 may be logically incorporated into the exclusion manager 212 for security. In some implementations, the exclusion registry 214 may be a database.

The system exclusion policy 206 may be stored in a system level configuration or be stored remotely and accessed by API call to an external network connected system, including cloud endpoints. A system level configuration may include another registry corresponding to the operating system such as the Windows Registry. As discussed previously, the system exclusion policy 206 may correspond to a type of exclusion designed to provide a generated effect such as performance, or operation criticality.

An endpoint protection application 208 may be the execution point for maintaining the security of the system 200. An endpoint protection application 208 may be an endpoint protection application designed to effectuate the actual verification of the system in light of the system exclusion policy. For example, the endpoint protection application 208 may be an anti-malware scanner. In this example, the endpoint protection application 208 may omit exclusion registrations as defined in the exclusion registry. In an example, in which the endpoint protection application 208 is “aware” of the exclusion manager 212, the endpoint protection application 208 may utilize inter-process communication to request and receive the pertinent exclusions based on the system exclusion policy 206. These requests may occur in real-time, or periodically, with the effective exclusion set cached by the endpoint protection application. In another example, in which the endpoint protection application 208 is not aware of the exclusion manager 212, the exclusion manager 212 may modify configuration file corresponding to the endpoint protection application 208 to include the relevant exclusions in light of the system exclusion policy 206.

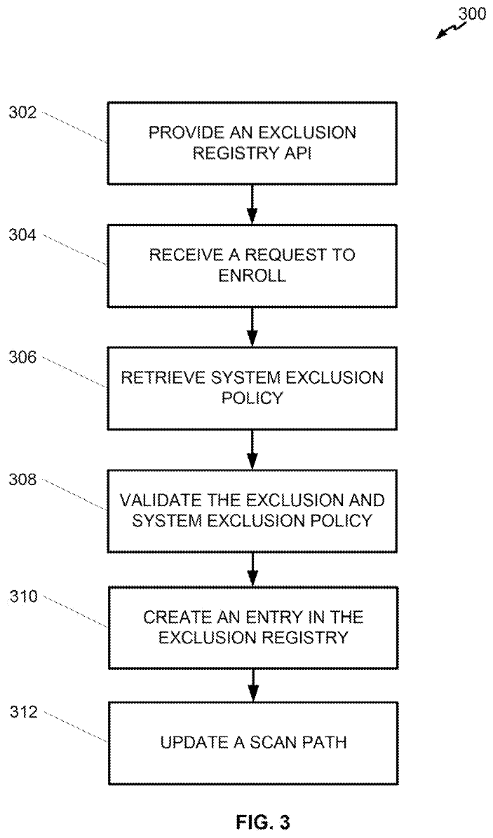

FIG. 3 illustrates a method for creating an exclusion registry according to an example. The method illustrated in FIG. 3 may be also be a computer implemented method. As such, references to the system 100 of FIG. 1 may be utilized for clarity.

At block 302, the processor 102 provides exclusion registry application program interface. The exclusion registry API, as described above, corresponds to a defined way to request an exclusion be registered or unregistered. The exclusion registry API may correspond to a shared library file within the system 100. In another example, the exclusion registry API may be a socket-based API utilizing communication sockets to transmit and receive messages on the localhost.

At block 304, the processor 102 receives a request to enroll an exclusion registration from a third-party software package via the exclusion registry API. The processor 102 may receive a request as defined by the exclusion registry API and communicated utilizing the channel also defined by the exclusion registry API.

At block 306, the processor 102 retrieves a system exclusion policy from a system registry. The processor 102 may utilize an exclusion manager 212 to retrieve the system exclusion policy from the system registry. In this example, the system registry may correspond to an operating system 202 configuration system such as the Windows Registry.

At block 308, the processor 102 validates that the exclusion registration is in compliance with the system exclusion policy. The exclusion manager 212 may compare the type of the system exclusion policy against the exclusion registration. The exclusion manager 212 may also compare publisher fields in the exclusion registration to an “allow-list” or “deny-list” of the system exclusion policy.

At block 310, the processor 102 validates that exclusion registration does not have a corresponding entry in an exclusion registry. In this example, the exclusion manager 212 may then query the exclusion registry 214 to determine in an entry corresponding to the exclusion request exists in the exclusion registry 214 already.

At block 312, the processor 102, responsive to the validation of the exclusion registration, creates an entry in the exclusion registry corresponding to the exclusion registration. As the create entry is the first entry within the exclusion registry corresponding to the exclusion registration, the entry may have a counter field initialized to one.

At block 314, the processor 102, updates a scan path for an endpoint protection application corresponding to an installed path of the third-party software package. As discussed previously, the exclusion manager 212 may update the configuration of the endpoint protection application. Additionally, the processor 102 may monitor any executable within the scan path. The monitoring may include scanning the file on disk within the path, or in another implementation, monitoring the behavior of the executable during actual execution.

In another example, the system 200 may choose to uninstall the third-party software 204. The method of updating the exclusion registry is similar to the enrollment method as illustrated in FIG. 3. The processor 102 receives a request to remove the entry from the exclusion registry. The request may be from an uninstaller package of the third-party software 204.

The processor 102 validates the counter is greater than zero a first time. The exclusion manager 212 executing on the processor may query the exclusion registry 214 for the entry requested to be removed. If the query is successful, the entry is present in the exclusion registry 214. The processor 102 decrements the counter. Upon validating an entry in the exclusion registry 214, the exclusion manager 212 may decrement the counter for the entry. The processor 102 validates the counter is greater than zero a second time. The processor 102, responsive to the validation of the second time, removes the entry from the exclusion registry. If the counter goes to zero, no third-party software 204 packages are utilizing the registration entry, and thus should be purged from the exclusion registry 214.

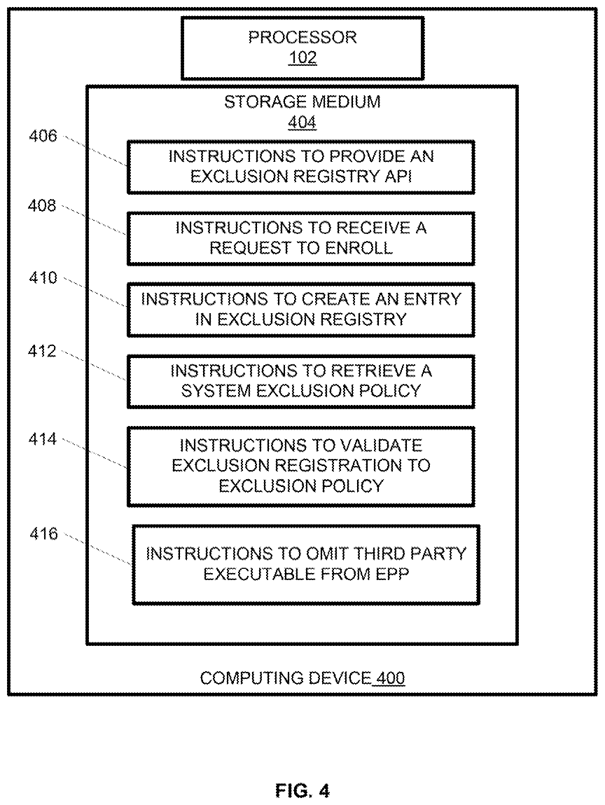

FIG. 4 is a computing device for supporting instructions for an exclusion registry, according to an example. The computing device 400 depicts a processor 102 and a storage medium 404 and, as an example of the computing device 400 performing its operations, the storage medium 404 may include instructions 406-416 that are executable by the processor 102. The processor 102 may be synonymous with the processor 102 referenced in FIG. 1. Additionally, the processor 102 may include but is not limited to central processing units (CPUs). The storage medium 404 can be said to store program instructions that, when executed by processor 102, implement the components of the computing device 400.

The executable program instructions stored in the storage medium 404 include, as an example, instructions to provide an exclusion registry API 406, instructions to receive a request to enroll an exclusion registration from a third-party software 408, instructions to create an entry in an exclusion registry for the exclusion registration 410, instructions to retrieve a system exclusion policy from a system registry 412, instructions to validate that exclusion registration is in compliance with the system exclusion policy 414, and instructions to, responsive to the validation, omit a third-party executable from the third-party software from being subject to an endpoint protection control 416.

Storage medium 404 represents generally any number of memory components capable of storing instructions that can be executed by processor 102. Storage medium 404 is non-transitory in the sense that it does not encompass a transitory signal but instead is made up of at least one memory component configured to store the relevant instructions. As a result, the storage medium 404 may be a non-transitory computer-readable storage medium. Storage medium 404 may be implemented in a single device or distributed across devices. Likewise, processor 102 represents any number of processors capable of executing instructions stored by storage medium 404. Processor 102 may be integrated in a single device or distributed across devices. Further, storage medium 404 may be fully or partially integrated in the same device as processor 102, or it may be separate but accessible to that computing device 400 and the processor 102.

In one example, the program instructions 406-418 may be part of an installation package that, when installed, can be executed by processor 102 to implement the components of the computing device 400. In this case, storage medium 404 may be a portable medium such as a CD, DVD, or flash drive, or a memory maintained by a server from which the installation package can be downloaded and installed. In another example, the program instructions may be part of an application or applications already installed. Here, storage medium 404 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a memory,
a processor, communicatively coupled to the memory, wherein the processor executes instructions to:
receive a request to enroll an exclusion registration from a third-party software;
create an entry in an exclusion registry for the exclusion registration;
retrieve a system exclusion policy from a system registry;
compare the system exclusion policy against the exclusion registration; and
responsive to the comparing, omit a third-party executable from the third-party software from being subject to an endpoint protection control.

2. The system of claim 1 wherein the exclusions registration comprises instructions to call an exclusion registry application program interface (API) corresponding to an exclusion manager.

3. The system of claim 1 wherein the exclusion registry tracks a counter corresponding to the exclusion registration for the third-party software is completed.

4. The system of claim 3 wherein the processor further executes instructions to:
receive a request to remove the entry from the exclusion registry;
validate the counter is greater than zero a first time;
decrement the counter;
validate the counter is greater than zero a second time; and
responsive to the validation of the second time, remove the entry from the exclusion registry.

5. The system of claim 1, the instructions to omit further comprising:
update a scan path for the endpoint protection application corresponding to an installed path of the third-party software.

6. A method comprising:
providing an exclusion registry application program interface (API);
receiving a request to enroll an exclusion registration from a third-party software package via the exclusion registry API;
retrieving a system exclusion policy from a system registry;
validating that exclusion registration is in compliance with the system exclusion policy;
validating that exclusion registration does not have a corresponding entry in an exclusion registry;
responsive to the validation of the exclusion registration, creating an entry in the exclusion registry corresponding to the exclusion registration; and
updating a scan path for an endpoint protection application corresponding to an installed path of the third-party software package.

7. The method of claim 6, wherein the exclusion registry tracks a counter corresponding to the exclusion registration for the third-party software is completed.

8. The method of claim 7 further comprising:
receiving a request to remove the entry from the exclusion registry;
validating the counter is greater than zero a first time;
decrementing the counter;
validating the counter is greater than zero a second time; and
responsive to the validation of the second time, removing the entry from the exclusion registry.

9. The method of claim 6 wherein the compliance is based on a publisher of the third-party software package.

10. The method of claim 6 wherein the request comprises a type corresponding to the exclusion registration.

11. A non-transitory computer readable medium comprising machine readable instructions that when executed cause a processor to:
provide an exclusion registry application program interface (API);
receive a request to enroll an exclusion registration from a third-party software;
create an entry in an exclusion registry for the exclusion registration;
retrieve a system exclusion policy from a system registry;
validate that the exclusion registration does not have a corresponding entry in an exclusion registry;
validate that exclusion registration is in compliance with the system exclusion policy; and
responsive to the validation, omit a third-party executable from the third-party software from being subject to an endpoint protection control.

12. The medium of claim 11, wherein the exclusion registry tracks a counter corresponding to the exclusion registration for the third-party software is completed.

13. The medium of claim 11, the instructions further comprising:
receive a request to remove the entry from the exclusion registry;
validate the counter is greater than zero a first time;
decrement the counter;
validate the counter is greater than zero a second time; and
responsive to the validation of the second time, remove the entry from the exclusion registry.

14. The medium of claim 13 wherein the request comprises a type corresponding to the exclusion registration.

15. The medium of claim 11, the instructions to omit further comprising:
update a scan path for the endpoint protection application corresponding to an installed path of the third-party software.
